(19) United States
(12) Patent Application Publication
(10) Pub. No.: US 2025/0367927 A1
(43) Pub. Date: Dec. 4, 2025

(54) LIQUID EJECTION HEAD

(71) Applicant: CANON KABUSHIKI KAISHA, Tokyo (JP)

(72) Inventor: MICHIKO JOHNSON, Tokyo (JP)

(21) Appl. No.: 19/226,564

(22) Filed: Jun. 3, 2025

(30) Foreign Application Priority Data
Jun. 4, 2024 (JP) 2024-090909

(51) Int. Cl. B41J 2/14; B41J 2/16

(52) U.S. Cl. CPC B41J 2/14201; B41J 2/14072; B41J 2/1623; B41J 2002/14362; B41J 2002/14491

(57) ABSTRACT

A liquid ejection head includes: an element substrate including a first flow path substrate having a first face and a second face, a second flow path substrate having a third face and a fourth face and including an energy generating element and a connection terminal, and a bonding layer that bonds the second face and the third face; a wiring substrate having an external terminal; an electrical connection portion that electrically connects the connection terminal to the external terminal; and a sealing resin that covers the electrical connection portion and an end portion of the fourth face of the bonding layer. A step that protrudes from at least one of the second face and the third face is provided between the second face and the third face, and the step is arranged at a position overlapping the connection terminal when viewed in a first direction.

### BACKGROUND

### Field

The present disclosure relates to a liquid ejection head.

### Description of the Related Art

In liquid ejection devices such as inkjet printers, a liquid ejection head that ejects a liquid such as an ink from a plurality of outlets is provided. As the liquid ejection head, one having a configuration including a flow-path-forming substrate that forms a flow path through which an ejected liquid passes and an outlet is conventionally known. The flow-path-forming substrate is formed by bonding a plurality of substrates, and since the bonding state influences the function of the liquid ejection head, various proposals have been made regarding the control of the bonding state.

Japanese Patent No. 6303285 discloses a liquid ejection head including a first substrate on which a vibration plate, a first step portion, and a second step portion are provided and a second substrate bonded to the first substrate with an adhesive in order to prevent the adhesive used to bond the substrates from flowing out.

### SUMMARY OF THE DISCLOSURE

As described above, in a configuration in which a plurality of substrates are bonded with an adhesive, air bubbles may be generated inside the bonding layer that bonds the substrates together during the production of the flow-path-forming substrate. For example, such air bubbles may cause problems such as reducing the bonding strength in wire bonding.

The present disclosure has been made in view of such technical background, and an object of the present disclosure is to provide a liquid ejection head that can reduce problems caused by air bubbles inside the bonding layer.

In order to achieve the object described above, a liquid ejection head according to the present disclosure includes:
an element substrate that includes:
   a first flow path substrate having a first face on which an outlet for ejecting a liquid is formed and a second face opposite to the first face;
   a second flow path substrate having a third face bonded to the second face of the first flow path substrate and a fourth face opposite to the third face, in which the second flow path substrate includes a flow path through which a liquid ejected from the outlet is supplied to the first flow path substrate, an energy generating element that generates energy for ejecting a liquid, and a connection terminal that is provided on the fourth face and supplies electricity to the energy generating element; and
   a bonding layer that is provided between the second face and the third face and bonds the second face and the third face,
a wiring substrate having an external terminal that is electrically connected to the connection terminal;
an electrical connection portion that electrically connects the connection terminal to the external terminal; and
a sealing resin that covers the electrical connection portion and an end portion of the fourth face of the bonding layer,
wherein a step that protrudes from at least one of the second face and the third face is provided between the second face and the third face, and the step is arranged at a position overlapping the connection terminal when viewed in a first direction perpendicular to the fourth face.

According to the present disclosure, it is possible to provide a liquid ejection head that can reduce problems caused by air bubbles inside the bonding layer.

Further features of the present disclosure will become apparent from the following description of exemplary embodiments with reference to the attached drawings.

### BRIEF DESCRIPTION OF THE DRAWINGS

FIG. 1 is an exploded perspective view of an element substrate according to a first embodiment;

FIG. 2 is a cross-sectional view of the element substrate according to the first embodiment;

FIG. 3 is a cross-sectional view of an element substrate according to a comparative example;

FIG. 4 is a diagram showing a state in which air bubbles are released into a sealing resin in the comparative example;

FIGS. 5A to 5I are explanatory diagrams showing an example of a method of producing the liquid ejection head according to the first embodiment;

FIG. 6 is a cross-sectional view showing a state in which air bubbles are generated in a bonding layer according to the first embodiment;

FIGS. 7A and 7B are transparent plan views of the element substrate according to the first embodiment;

FIG. 8 is a cross-sectional view of an element substrate according to a second embodiment;

FIG. 9 is a cross-sectional view showing details of a step portion according to the second embodiment;

FIGS. 10A to 10C are explanatory diagrams illustrating a state in which air bubbles are released into a sealing resin;

FIGS. 11A to 11E are transparent plan views showing PADs and steps according to another embodiment;

FIG. 12 is a perspective view of the liquid ejection head according to the first embodiment; and

FIG. 13 is a perspective view showing a detailed configuration of a liquid ejection unit according to the first embodiment.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments.

The present disclosure is particularly suitable for a liquid ejection device that ejects an ink as a recording fluid onto a recording medium such as paper and records an image, and a liquid ejection head provided in the liquid ejection device. Hereinafter, an embodiment in which the present disclosure is applied to an inkjet head that ejects an ink onto a recording medium by driving an actuator provided in an element substrate, and records an image on the recording medium will be described. However, the present disclosure can also be applied to devices such as an inkjet head that ejects a liquid other than an ink and other liquid ejection heads.

### First Embodiment

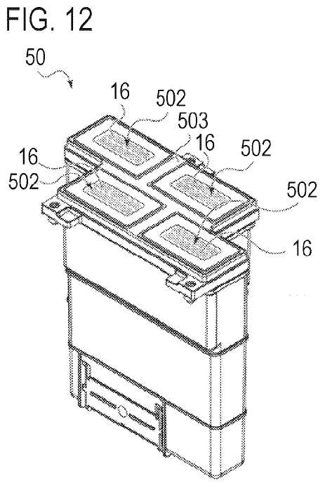

FIG. 12 is a perspective view showing a liquid ejection head 50 according to the present embodiment.

As shown in FIG. 12, a head portion of the liquid ejection head 50 includes liquid ejection units 502 having a mechanism for ejecting a liquid and a common support member 503 that supports the plurality of liquid ejection units 502.

In the present embodiment, four liquid ejection units 502 are arranged in a zigzag on the common support member 503. About 1,000 outlets 16 are formed in each of the liquid ejection units 502, and the liquid ejection unit 502 can eject a liquid from the outlet 16 and perform recording at 1,200 dpi.

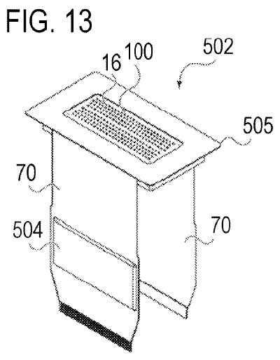

FIG. 13 is a perspective view showing a detailed configuration of the liquid ejection unit 502 shown in FIG. 12. As shown in FIG. 13, the liquid ejection unit 502 includes an element substrate 100 including the outlet 16 for ejecting a liquid, a liquid flow path that communicates with the outlet, an energy generating element and the like, and a wiring substrate 70 that is electrically connected to the element substrate 100. Examples of wiring substrates 70 include flexible printed circuits (FPC) and tape automated bonding (TAB).

A liquid ejection unit 202 includes a support member 505 for reinforcing the element substrate 100. The support member 505 is bonded to an ejection face side of the element substrate 100. In the wiring substrate 70, a drive circuit substrate 504 for driving an energy generating element (not shown) that generates energy for ejecting a liquid is provided. Here, in the present embodiment, a piezoelectric element is used as the energy generating element.

The wiring substrate 70 is a flexible wiring substrate that is connected to the element substrate 100 and the liquid ejection device, and transmits power from the liquid ejection device to the element substrate 100. In the wiring substrate 70, contacts that are electrically connected to the liquid ejection device and external terminals that are electrically connected to the element substrate 100 are provided.

Here, regarding the inkjet head, as described above, the inkjet head may be provided separately from an ink tank and an ink may be supplied through a tube or the like. In addition, the inkjet head may be applied in an integrated form with the ink tank. For example, the ink tank may be detachably attached, and when there is no remaining ink in the ink tank, the ink tank may be removed and a new ink tank may be attached. In addition, the inkjet head may be one that is applied to a serial recording method as described above or may be one that is applied to a line printer and having nozzles over a range corresponding to the full width of recording media.

### Element Substrate 100

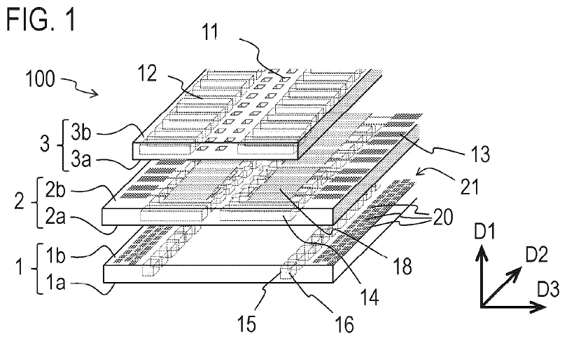

The configuration of the element substrate 100 will be described. FIG. 1 is an exploded perspective view of the element substrate 100. As shown in FIG. 1, the element substrate 100 has a configuration in which three substrates, a first flow path substrate 1, a second flow path substrate 2, and a third flow path substrate 3 are laminated. Here, the basic configuration of the element substrate 100 to be described below is only an example, and the configuration of the liquid ejection head to which the present disclosure can be applied is not limited thereto. In addition, in the drawings, components of the element substrate 100 are shown in a simplified manner, only representative components are shown, and some configurations may be omitted.

Hereinafter, a direction in which the first flow path substrate 1, the second flow path substrate 2, and the third flow path substrate 3 are laminated and which is perpendicular to the bonding faces of the substrates is defined as a first direction D1. In addition, a direction along one side of the first flow path substrate 1 is defined as a second direction D2, and a direction which intersects the second direction D2 and is along another side of the first flow path substrate 1 is defined as a third direction D3. In a first embodiment, the first direction D1, the second direction D2, and the third direction D3 are perpendicular to each other. In addition, the first direction D1 is a direction that is substantially parallel to the liquid ejection direction of the liquid ejection head 50.

The first flow path substrate 1, the second flow path substrate 2, and the third flow path substrate 3 are each a plate-like flow-path-forming member in which a flow path through which an ink passes is formed. In the first embodiment, the first flow path substrate 1, the second flow path substrate 2, and the third flow path substrate 3 are laminated in this order to form the element substrate 100.

The first flow path substrate 1 has a first face 1a in which the outlet 16 for ejecting an ink is formed and a second face 1b in which a flow path 15 communicating with the outlet 16 opens. The first face 1a and the second face 1b are faces that face in opposite directions and faces that are perpendicular to the first direction D1. The second face 1b is a bonding face that is bonded to the second flow path substrate 2.

In the first flow path substrate 1, outlet rows in which the plurality of outlets 16 are arranged side by side in the second direction D2, are provided at one end portion and the other end portion in the third direction D3. Thus, the flow path 15 is formed to correspond to each outlet 16.

On the second face 1b of the first flow path substrate 1, a step portion 21 formed by a plurality of steps 20 that protrude from the second face 1b toward the second flow path substrate 2 is provided. In the first embodiment, a plurality of rows of steps each including a plurality of steps 20 arranged side by side in the second direction D2 are provided. FIG. 1 shows a state in which the step portion 21 formed by three rows of steps are provided at one end portion and the other end portion of the first flow path substrate 1 in the third direction, but the configuration of the step portion 21 is not limited thereto. The steps 20 are arranged at positions overlapping PADs 13 provided on the second flow path substrate 2 when viewed in the first direction D1.

The second flow path substrate 2 has a third face 2a bonded to the second face 1b of the first flow path substrate 1 and a fourth face 2b on which a plurality of energy generating elements 18 and a plurality of PADs 13 are provided. The third face 2a and the fourth face 2b are faces that face in opposite directions and faces that are perpendicular to the first direction D1. The fourth face 2b is a bonding face that is bonded to the third flow path substrate 3. The PAD 13 is a connection terminal (electrode pad) for supplying electricity to the energy generating element 18. In addition, in the second flow path substrate 2, a plurality of pressure chambers 14 that open to the third face 2a are formed. The pressure chamber 14 functions as a flow path through which an ink flowing in from the third flow path substrate 3 flows to the first flow path substrate 1.

The third flow path substrate 3 has a fifth face 3a that is bonded to the third face 2a of the second flow path substrate 2 and a sixth face 3b in which a plurality of inlets 11 for an ink to flow in are formed. The fifth face 3a and the sixth face 3b are faces that face in opposite directions and are faces that are perpendicular to the first direction D1. A flow path formed inside the third flow path substrate 3 and having the inlet 11 at one end opens to the fifth face 3a. In addition, in the third flow path substrate 3, a plurality of housing portions 12 in which the energy generating elements 18 are arranged are formed. The energy generating element 18 generates energy for ejecting an ink from the outlet 16.

In the element substrate 100, an ink flows in from the inlet 11 of the third flow path substrate 3, passes through the pressure chamber 14 of the second flow path substrate 2 and the flow path 15 of the first flow path substrate 1, and is ejected from the outlet 16. That is, inside the element substrate 100, a continuous through-hole having the inlet 11 at one end and the outlet 16 at the other end is formed as a flow path. The flow path may be formed to connect one inlet 11 to one outlet 16 or may be formed to connect a plurality of outlets 16 to one inlet 11.

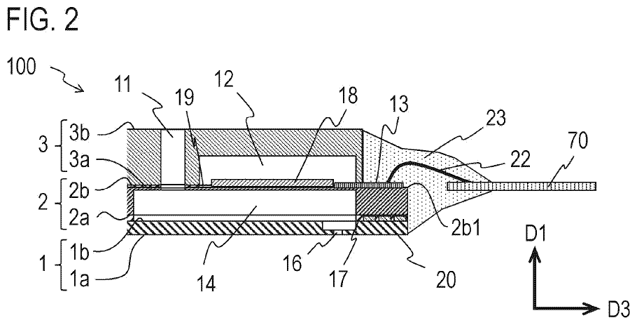

FIG. 2 is a cross-sectional view of the element substrate 100 when viewed in the second direction D2, and shows the internal configuration of the element substrate 100. The second face 1b of the first flow path substrate 1 and the third face 2a of the second flow path substrate 2 are bonded to each other with, for example, an adhesive to form a bonding layer (bonding portion) 17. In addition, the fourth face 2b of the second flow path substrate 2 and the fifth face 3a of the third flow path substrate 3 are bonded to each other with, for example, an adhesive to form a bonding layer (bonding portion) 19.

For example, a piezoelectric element can be used as the energy generating element 18 provided inside the housing portion 12. When a vibration plate is provided to cover a part of the housing portion 12 that opens to the fifth face 3a, and a piezoelectric element is provided on the vibration plate, the piezoelectric element functions as the energy generating element 18 that generates energy for ejecting an ink from the outlet 16. In addition, as the energy generating element 18, for example, a heating element that generates thermal energy for ejecting an ink, such as a heater, can be used. The energy generating element 18 is electrically connected to the PAD 13 via a wiring.

To the PAD 13 provided on the fourth face 2b of the second flow path substrate 2, one end portion of a wire 22, which is a connection member for electrically connecting the element substrate 100 and the wiring substrate 70, is connected. The other end portion of the wire 22 is connected to an external terminal provided on the wiring substrate 70. In the first embodiment, the external terminal is positioned on the side in the third direction D3 with respect to the element substrate 100. Therefore, the wire 22 is arranged from above the PAD 13 to above the wiring substrate 70 to span across a side 2b1 of the fourth face 2b of the second flow path substrate 2 that extends in the second direction D2 in the third direction D3. Here, the end portion on the side opposite to the end portion of the second flow path substrate 2 in the third direction D3 shown in FIG. 2 is similarly formed.

In order to protect the wire 22 that serves as an electrical connection portion for electrically connecting the PAD 13 to the external terminal, the wire 22 is covered with a sealing resin 23. Additionally, the sealing resin 23 is provided to cover the connection portion between the PAD 13 and the wire 22, the end face of the element substrate 100 in the third direction D3, and the connection portion between the external terminal of the wiring substrate 70 and the wire 22. The sealing resin 23 is provided to cover at least the end face of the second flow path substrate 2 along the side 2b1 across which the wire 22 spans and the end portion of the bonding layer 17 closer to the side 2b1. Here, the electrical connection portion to which the present disclosure can be applied is not limited to the wire, and for example, the electrical connection portion that electrically connects the PAD 13 to the external terminal may be an inner lead of the wiring substrate 70.

Respective components of the first flow path substrate 1, the second flow path substrate 2, and the third flow path substrate 3 are formed, for example, by processing a silicon (Si) single crystal substrate using a semiconductor production technique such as etching.

### Comparative Example

In the first embodiment, the step portion 21 is provided on the second face 1b of the first flow path substrate 1. The step portion 21 is provided to reduce problems caused by air bubbles when air bubbles are generated inside the bonding layer 17. Therefore, first, problems that may be caused by air bubbles generated in the bonding layer 17 will be described using a comparative example in which the step portion 21 is not provided.

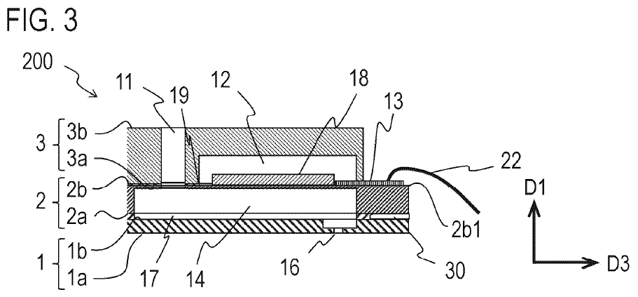

FIG. 3 is a cross-sectional view of an element substrate 200 according to a comparative example when viewed in the second direction D2, and shows the internal configuration of the element substrate 200. The element substrate 200 differs from the element substrate 100 according to the first embodiment in that the step portion 21 is not provided. Hereinafter, in the comparative example, the same components as those in the first embodiment will be denoted with the same reference numerals, and descriptions thereof will be omitted.

In the comparative example, the second face 1b of the first flow path substrate 1 and the third face 2a of the second flow path substrate 2 are each flat, and the first flow path substrate 1 and the second flow path substrate 2 are bonded together on their flat faces. When the first flow path substrate 1 and the second flow path substrate 2 are bonded together, air bubbles may be generated inside the bonding layer 17. FIG. 3 shows an example in which air bubbles 30 are generated at the end of the bonding layer 17 in the third direction D3 when the wire 22 is connected to the element substrate 200 and the wire 22 is not yet covered with the sealing resin 23.

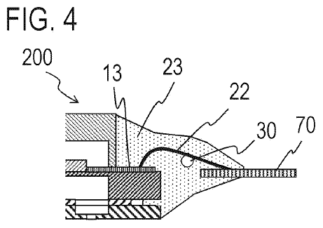

In the state shown in FIG. 3, when the sealing resin 23 is applied (filled) to cover the ends of the wire 22 and the bonding layer 17, air bubbles in the bonding layer 17 may be released into the sealing resin 23. FIG. 4 shows a state in which the air bubbles 30 are released into the sealing resin 23 in the element substrate 200 according to the comparative example.

In the comparative example, when the air bubbles 30 larger than the size of the wire mounting area are generated directly below the PAD 13 in the bonding layer 17, an ultrasonic electromotive force during compression of the wire bonding for connecting the wire 22 may be impaired and the bonding strength may decrease. In addition, when the air bubbles 30 are released into the sealing resin 23, there is a risk of problems such as a decrease in the bonding strength due to the air bubbles 30 coming into contact with the wire 22 and the occurrence of short-circuiting due to impaired electrical insulation caused by formation of a space between the adjacent wires 22. In this manner, the air bubbles in the bonding layer 17 may cause various problems such as element substrate production defects or failures, and may have adverse influences.

### Method of Producing Liquid Ejection Head

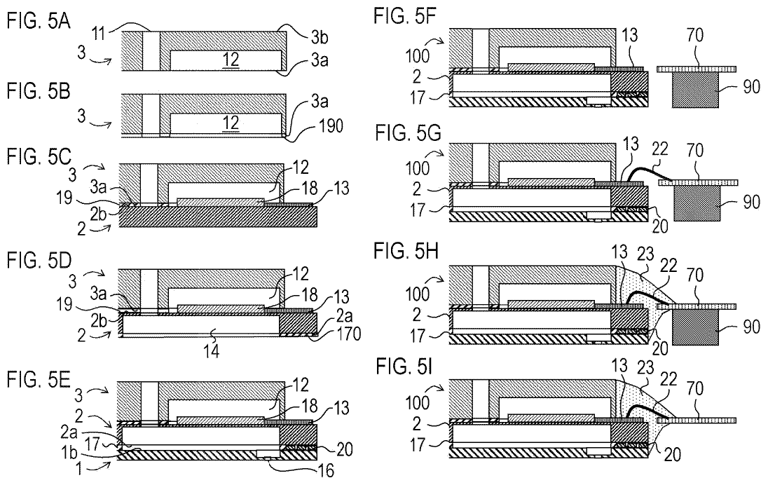

In order to reduce problems caused by air bubbles generated in the bonding layer 17, in the first embodiment, the step portion 21 is provided between the second face 1b and the third face 2a. Here, a method of producing the liquid ejection head 50 including the step portion 21 will be described. FIGS. 5A to 5I are explanatory diagrams showing an example of a method of producing the liquid ejection head 50 according to the first embodiment, and mainly showing a process of producing the element substrate 100 and a process of connecting the element substrate 100 to the wiring substrate 70.

FIG. 5A shows the third flow path substrate 3 on which the flow path including the inlet 11 and the housing portion 12 are formed. The inlet 11 is formed on the sixth face 3b, and the flow path is formed to penetrate from the sixth face 3b to the fifth face 3a of the third flow path substrate 3. The housing portion 12 is formed on the side of the fifth face 3a.

FIG. 5B shows a state in which an adhesive is transferred to the fifth face 3a of the third flow path substrate 3. An adhesive 190 for bonding to the second flow path substrate 2 is applied to the entire fifth face 3a.

FIG. 5C shows at state in which the second flow path substrate 2 and the third flow path substrate 3 are bonded together. The fourth face 2b of the second flow path substrate 2 and the fifth face 3a of the third flow path substrate 3 are bonded together via the adhesive 190, and the bonding layer 19 is formed between the second flow path substrate 2 and the third flow path substrate 3. In this case, the two substrates are bonded together so that the energy generating element 18 provided on the fourth face 2b of the second flow path substrate 2 is stored inside the housing portion 12 formed on the third flow path substrate 3.

The bonding is performed by adhering the second flow path substrate 2 to the adhesive layer transferred to the third flow path substrate 3 and thermally curing the adhesive 190 while applying a pressure of 5 kN to the adhesive layer. In this case, when pressure and heat are applied uniformly to the face, minute unevennesses that are generated when the adhesive is transferred are crushed and the bonding layer 19 with few air bubbles can be obtained.

FIG. 5D shows a state in which the pressure chamber 14 that opens to the third face 2a of the second flow path substrate 2 is formed, and an adhesive 170 is transferred to the third face 2a. The pressure chamber 14 can be formed by dry etching or the like. The pressure chamber 14 is formed to communicate with the flow path formed on the third flow path substrate 3. In addition, the adhesive 170 is transferred after the pressure chamber 14 is formed.

FIG. 5E shows a state in which the first flow path substrate 1 and the second flow path substrate 2 are bonded together. The second face 1b of the first flow path substrate 1 and the third face 2a of the second flow path substrate 2 are bonded together via the adhesive 170, and the bonding layer 17 is formed between the first flow path substrate 1 and the second flow path substrate 2. The bonding is performed in the same manner as the bonding between the second flow path substrate 2 and the third flow path substrate 3. When the first flow path substrate 1 and the second flow path substrate 2 are bonded together, the element substrate 100 is completed.

In the second flow path substrate 2, in order to expose the PAD 13 to which the wire 22 is connected in the subsequent wire bonding process, a part of the third flow path substrate 3 is hollowed out to correspond to the PAD 13. That is, when viewed in the first direction D1, the PAD 13 has a part that does not overlap the third flow path substrate 3. In such a configuration, in the process of bonding the first flow path substrate 1 and the second flow path substrate 2, pressure may be applied while supporting the first face 1a of the first flow path substrate 1 and the sixth face 3b of the third flow path substrate 3. Then, when the first flow path substrate 1 is adhered to the second flow path substrate 2 and pressure is applied, pressure is unlikely to be applied to a part in which the third flow path substrate 3 is not provided and which overlaps the PAD 13 in the first direction D1. Therefore, in a part of the bonding layer 17 where the third flow path substrate 3 is not positioned directly below and directly above the PAD 13, the unevenness of the transferred adhesive 170 is unable to be completely crushed, and air bubbles are relatively easily formed.

However, in the first embodiment, the step portion 21 including the plurality of steps 20 is provided between the second face 1b and the third face 2a, that is, in a part of the bonding layer 17 where the third flow path substrate 3 is not positioned directly below and directly above the PAD 13. The step portion 21 prevents large-sized air bubbles from being generated and prevents the air bubbles from moving to the inside of the sealing resin 23 in the subsequent process. The effect of reducing the size and preventing movement of air bubbles obtained by the step portion 21 will be described below in detail.

FIG. 5F shows the element substrate 100 and the wiring substrate 70 installed on a jig 90. After the element substrate 100 is completed, the element substrate 100 is electrically connected to the wiring substrate 70 via the PAD 13. The element substrate 100 and the wiring substrate 70 are connected when the wiring substrate 70 is installed on the jig 90.

FIG. 5G shows a state in which the wire 22 is connected to the element substrate 100 and the wiring substrate 70, and the element substrate 100 and the wiring substrate 70 are electrically connected. By wire bonding, one end portion of the wire 22 is connected to the PAD 13 of the element substrate 100, and the other end portion is connected to the external terminal provided on the wiring substrate 70.

FIG. 5H shows a state in which the wire 22 is covered with the sealing resin 23. The sealing resin 23 is cured by heating for a certain time. In order to protect not only the wire 22 but also the PAD 13, the wiring substrate 70 and the like, the sealing resin 23 is provided to cover the exposed portion of the PAD 13 and the external terminal of the wiring substrate 70. In addition, the sealing resin 23 is provided to cover at least the end face of the second flow path substrate 2 and the end portion of the bonding layer 17 within the end faces of the element substrate 100 on the side of the wiring substrate 70 in the third direction D3.

If heat generated when the sealing resin 23 is cured is transmitted to the element substrate 100, when there are air bubbles that communicate with the end portion of the bonding layer 17 of the element substrate 100, the internal pressure of the air bubbles may increase, and the air bubbles may be released into the sealing resin 23. However, in the first embodiment, since the step 20 is provided along the end face that faces the side of the wiring substrate 70 of the element substrate 100, it is possible to prevent air bubbles from being generated at positions where they may come into contact with the sealing resin 23 and prevent the air bubbles from moving inside the sealing resin 23.

FIG. 5I shows a state in which the jig 90 is removed. After the sealing resin 23 is cured, the jig 90 is removed from the wiring substrate 70. Then, the wiring substrate 70 is fixed to a housing 60, an ink is injected into the housing 60, and thus the liquid ejection head 50 is completed.

### Step Portion

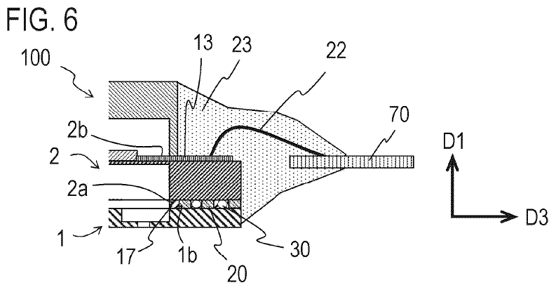

Next, the configuration and operational effects of the step portion 21 according to the first embodiment will be described in detail. FIG. 6 is a cross-sectional view showing a state in which the air bubbles 30 are generated in the bonding layer 17 of the element substrate 100 according to the first embodiment.

First, the size of the step 20 in the height direction will be exemplified. In the first embodiment, the thickness of the bonding layer 17, that is, the distance between the second face 1b of the first flow path substrate 1 and the third face 2a of the second flow path substrate 2, is set to at least 5 μm and not more than 6 μm. Then, the height of the step 20 is set to about 5 μm so that the distance from the step 20 to the third face 2a is at least 0.1 μm and not more than 0.3 μm. In this manner, the height of the step 20 is set so that the interval between the step 20 and the third face 2a is extremely smaller (for example, 1/10 or less) than the interval between the second face 1b and the third face 2a.

During the process of bonding the first flow path substrate 1 and the second flow path substrate 2, since heat for curing is applied to the adhesive 170, the adhesive viscosity decreases. In the first embodiment, the flow resistance of the adhesive 170 is higher in a part where the step 20 is provided than in a part where the step 20 is not provided. This is because the interval between the step 20 and the third face 2a is smaller than the interval between the second face 1b and the third face 2a. Therefore, when the air bubbles 30 are generated in the bonding process, the air bubbles 30 do not move between the step 20 and the third face 2a, but remain in the thicker part of the bonding layer 17 where there is no step 20 between the second face 1b and the third face 2a, which have a lower flow resistance.

In the first embodiment, three rows of steps each including a plurality of steps 20 arranged in the second direction D2 are provided at positions that overlap the PAD 13 at the end portion of the first flow path substrate 1 in the first direction D1. Therefore, the air bubbles 30 generated in the bonding process are trapped between the steps 20 in the second direction D2 and the third direction D3. That is, in the first embodiment, even if the air bubbles 30 are generated, since the air bubbles 30 are divided by the steps 20, the occurrence of air bubbles 30 having a size equal to or larger than the interval between the adjacent steps 20 is reduced.

In this manner, when the step 20 is arranged inside the bonding layer 17 at a position that overlaps the PAD 13 arranged on the fourth face 2b of the second flow path substrate 2 in the third direction D3, this prevents voids from occurring in a part that communicates with the tip end portion and air bubbles from being released into a sealing agent near the wire to be bonded during mounting in the next process. This makes it possible to reduce the influence of air bubbles on the bonding face on the next process.

Here, in the first embodiment, the distance from the step 20 to the third face 2a is set to at least 0.1 μm and not more than 0.3 μm, and the height of the step 20 is set to about 5 μm, but the configuration to which the present disclosure is applied is not limited thereto. In this case of this structure, the thickness of the bonding layer 17 after the bonding process, particularly, the thickness of the bonding layer 17 in an area where the steps 20 are arranged, depends on the height of the step 20. In addition, the thickness of the adhesive 170 transferred to the bonding face varies depending on the type of the adhesive, the state of the bonding face and the like, and may be set in a range of at least 0.5 μm and not more than 10 μm. For example, when the thickness of the adhesive 170 is significantly smaller than the interval between the second face 1b and the third face 2a, and the interval between the step 20 and the third face 2a is small, the adhesive may not sufficiently spread between the second face 1b and the third face 2a. This may adversely induce the occurrence of the air bubbles 30, which may reduce the bonding strength of the bonding face. Therefore, the height of the step 20 should be appropriately set in consideration of the distance between the bonding faces, the thickness of the adhesive and the like. Specifically, it is desirable to set the height of the step 20 to at least 0.1 μm and not more than 5 μm.

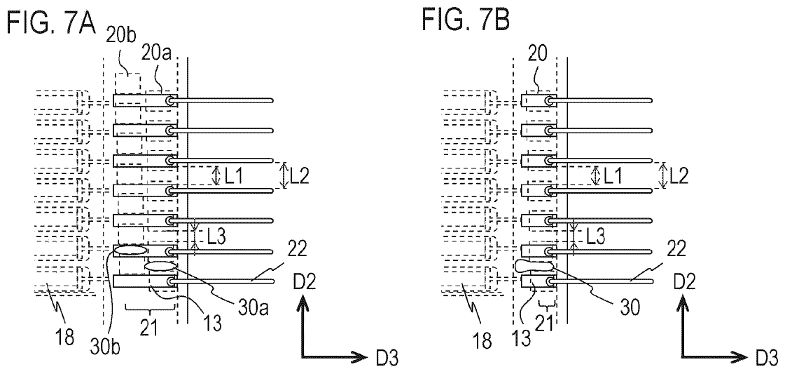

Next, the size of the interval between the steps 20 will be exemplified. FIGS. 7A and 7B are transparent plan views of the element substrate 100 when viewed in a direction perpendicular to the second face 1b, and show only the main configuration such as the step portion 21. Hereinafter, two configuration examples of the step portion 21 will be described in order with reference to FIGS. 7A and 7B.

FIG. 7A shows an example in which the step portion 21 provided on the first flow path substrate 1 is formed by two rows of steps. Among the steps 20 forming the step portion 21, the steps will be referred to as a step 20a, a step 20b and the like in order from the closest to the end face (scribe line) of the first flow path substrate 1 in the third direction D3. That is, in the first flow path substrate 1, a first step row in which the steps 20a are arranged at equal intervals in the second direction D2 and a second step row in which the steps 20b are arranged at equal intervals in the second direction D2 are arranged side by side in the third direction D3.

Since the thickness of the bonding layer 17 between the step 20 and the third face 2a, which is the bonding face, is thin, and air bubbles 30 are unlikely to exist, when the air bubbles 30 are generated, they move to an area where there are no steps 20. That is, since the air bubbles 30 are positioned in a space surrounded by the plurality of steps 20, the size of the air bubbles 30 contributes to the size of the interval between the steps 20. In this manner, when the step portion 21 formed by the plurality of steps 20 is provided, the size of the generated air bubbles 30 can be controlled to be equal to or smaller than the interval between the steps 20.

In the configuration example shown in FIG. 7A, the PADs 13 have a rectangular shape with the third direction D3 as a long side direction, and the size is 50 μm×500 μm. Here, the PADs 13 are arranged at equal intervals in the second direction D2, and a distance L1 between the PADs 13 in the second direction D2 is 30 μm.

The diameter of the wire 22 connected to each PAD 13 is 20 μm. The wire 22 is arranged approximately at the center of the PAD 13 in the second direction D2, and a distance L2 between the wires 22 in the second direction D2 is about 60 μm, which is larger than the distance L1.

The step 20 has a rectangular shape with the third direction D3 as the long side direction when viewed in the first direction D1, and the size is 70 μm×200 μm. The center line of the step 20a and the center line of the PAD 13 are at the same position in the second direction D2. Therefore, a distance L3 between the steps 20a in the second direction D2 is 10 μm. In addition, a distance between the steps 20b in the second direction D2 is also the distance L3.

The distance between the step 20a and the step 20b in the third direction D3 may be appropriately set in consideration of the size of the air bubbles 30 and the flowability of the adhesive 170. For example, if the adhesive 170 spreads sufficiently over the entire bonding face, the distance may be set to zero, and the step 20a and the step 20b may be formed to be connected in the third direction D3.

FIG. 7A shows a state in which air bubbles 30a are formed in a space surrounded by two steps 20a and one step 20b, and air bubbles 30b are formed in a space surrounded by one step 20a and two steps 20b. The air bubbles 30a face the end face of the first flow path substrate 1, and the air bubbles 30b are positioned further inside the first flow path substrate 1 than the step 20a.

In this configuration example, the size of the air bubbles 30a is reduced to a maximum of about 10 μm×200 μm. When the height of the step 20 is 5 μm, the size of the air bubbles 30 released into the sealing resin 23 is a maximum of about 27 μm. Since the distance between the adjacent wires 22 is about 60 μm, even if the air bubbles 30 come into contact with the wire 22, the wire 22 may not be broken or short-circuited, and problems caused by the air bubbles 30 can be reduced.

In addition, in this configuration example, since the center lines of the step 20a and the wire 22 in the second direction D2 are substantially the same, the air bubbles 30a are formed and released at the center between the adjacent wires 22. Therefore, in the first place, it is possible to directly reduce the opportunities for the air bubbles 30a to come into contact with the wire 22. That is, according to this configuration example, when the size of the air bubbles 30a is made smaller than the distance between the wires 22 and the air bubbles 30a are controlled such that they are generated in an area where there are no wires 22, problems caused by the air bubbles 30 coming into contact with the wire 22 can be avoided.

In this manner, it is desirable that the distance L3 between the steps 20 in the second direction D2 be set so that the generated air bubbles 30 are generated with a size small enough not to cause any problem. Specifically, it is preferable that the distance L3 be smaller than the distance L1 between the PADs 13 in the second direction D2 and the distance L2 between the wires 22 in the second direction D2.

In addition, as shown in FIG. 7A, the steps 20a and the steps 20b are arranged in a zigzag so that they are alternately arranged in the second direction D2. In such a configuration, the air bubbles 30 can be prevented from becoming larger in the third direction D3. In addition, since the adhesive 170 is filled between the steps 20, the substrates are reliably bonded together while maintaining sufficient adhesion strength required for bonding the substrates together. In addition, according to this configuration, when ultrasonic waves are added to press-bond the wire 22 to the PAD 13 in a process subsequent to the bonding process, it is possible to reduce the transmission loss of ultrasonic waves and minimize a decrease in the press-bonding strength.

In addition, the air bubbles 30b formed inward from the step 20a do not face the end face of the first flow path substrate 1 and thus do not move into the sealing resin 23. In this manner, when the step 20 is provided at the end portion of the first flow path substrate 1, it is possible to obtain an effect of directly preventing the movement of the air bubbles 30.

FIG. 7B shows an example in which the step portion 21 provided on the first flow path substrate 1 is formed by one row of steps. In this configuration example, the distance L1 between the PADs 13, the distance L2 between the wires 22, and the distance L3 between the steps 20 are all the same as those in the configuration example shown in FIG. 7A. In such a configuration, compared to a configuration in which the step portion 21 is not provided, it is possible to obtain an effect of minimizing the size of the air bubbles 30 and an effect of preventing movement into the sealing resin 23. Therefore, for example, when the distance from the energy generating element 18 to the end face of the element substrate 100 is short and it is difficult to arrange a plurality of rows of steps side by side, the occurrence of problems caused by the air bubbles 30 may be reduced by providing the step portion 21 formed by one row of steps. In addition, if sufficient bonding strength is obtained, for example, the step portion 21 may be formed by one step that is long in the second direction D2 such that the plurality of steps 20 are connected in the second direction D2, and the air bubbles 30 may be prevented from being released into the sealing resin 23.

### Second Embodiment

Next, a second embodiment according to the present disclosure will be described. The second embodiment differs from the first embodiment in the configuration of the step portion. Hereinafter, in the second embodiment, only components different from those in the first embodiment will be described. In the second embodiment, the same components as those in the first embodiment will be denoted with the same reference numerals, and descriptions thereof will be omitted.

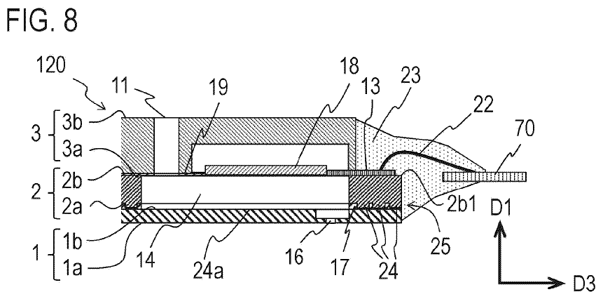

FIG. 8 is a cross-sectional view of an element substrate 120 according to the second embodiment when viewed in the second direction D2, and shows the internal configuration of the element substrate 120. In the first embodiment, the step portion 21 is formed by the plurality of steps 20 provided on the second face 1b of the first flow path substrate 1, but a step portion 25 according to the second embodiment is formed by a plurality of steps 24 provided on the third face 2a of the second flow path substrate 2.

The step portion 25 is provided at the end portion of the second flow path substrate 2 on the side 2b1 closer to the wiring substrate 70, and includes a plurality of step rows formed by the plurality of steps 24 arranged in the second direction D2. The end face of the step 24 on the side 2b1 in the step row provided at the position closest to the side 2b1 is formed on the same plane as the end face of the second flow path substrate 2 on the side 2b1.

For example, the step 24 can be formed by etching the second flow path substrate 2. In this case, the third face 2a of the second flow path substrate 2 becomes a recessed face that is recessed by etching. Thus, the step 24 is formed to protrude from the third face 2a toward the second face 1b of the first flow path substrate 1. In the second embodiment, the pressure chamber 14 is formed at a position deeper than the third face 2a of the second flow path substrate 2, that is, on the side closer to the third flow path substrate 3.

In the bonding process, the adhesive 170 is filled on the third face 2a, that is, in a depressed portion formed by the step 24, and the second face 1b of the first flow path substrate 1 and the third face 2a of the second flow path substrate 2 are bonded together. In this case, the two substrates may be bonded together so that the step 24 abuts against the second face 1b of the first flow path substrate 1 or the two substrates may be bonded together so that the step 24 faces the second face 1b and is spaced apart from the second face 1b. In either case, the bonding layer 17 is formed so that the distance between the second face 1b of the first flow path substrate 1 and the third face 2a of the second flow path substrate 2 is larger than the distance between the second face 1b and the step 24.

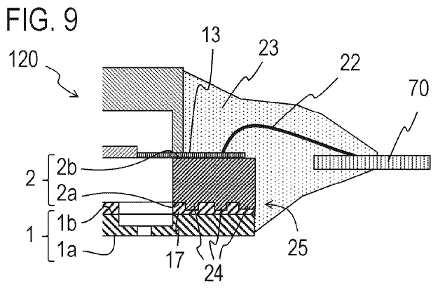

FIG. 9 is a cross-sectional view showing details of the step portion 25 according to the second embodiment. The third face 2a of the second flow path substrate 2 is formed inward from the scribed end portion of the second flow path substrate 2 so that it does not overlap the scribed area. In this manner, the steps 24 can be formed with a sufficient height, and when air bubbles are generated in the depressed portion between the steps 24, it is possible to prevent the air bubbles from moving between the steps 24, where the thickness of the bonding layer 17 is thin, and the second face 1b of the first flow path substrate 1. Therefore, it is possible to prevent air bubbles from being released into the sealing resin 23 from the end portion of the bonding layer 17.

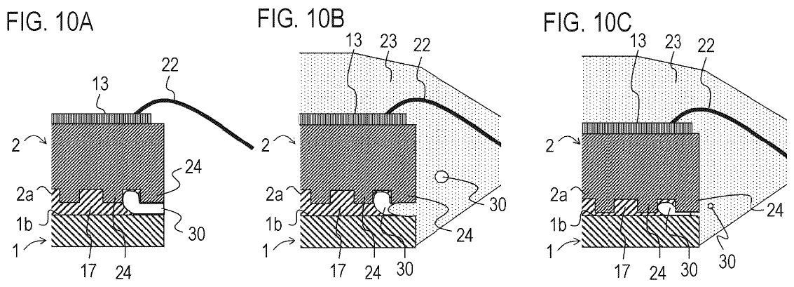

FIGS. 10A to 10C are explanatory diagrams illustrating a state in which the air bubbles 30 are released into the sealing resin 23. FIG. 10A shows a state in which air bubbles 30 that communicate with the scribed area are generated at the end portion of the bonding layer 17. FIG. 10B shows a comparative example in which the distance between the second face 1b and the third face 2a is larger than that in the second embodiment and shows a state in which the sealing resin 23 is filled. FIG. 10C shows a state in which the sealing resin 23 is filled in the second embodiment.

When the sealing resin 23 is filled so that the sealing resin 23 covers the end portion of the bonding layer 17, the air bubbles 30 heated when the sealing resin 23 is cured expand, and some of the air bubbles are released into the sealing resin 23. In this case, the sealing resin 23 in an amount equivalent to accumulated released air bubbles 30 enters the bonding layer 17 in place of the air bubbles 30. As shown in FIG. 10B, when large-sized air bubbles 30 are released into the sealing resin 23, problems are highly likely to occur.

On the other hand, in the second embodiment, the adhesive 170 is crushed to form the bonding layer 17 so that at least the distance between the step 24 and the second face 1b is 0.3 μm or less. In such a configuration, the rate at which the air bubbles 30 released into the sealing resin 23 are replaced with the sealing resin 23 that has entered between the step 24 and the second face 1b decreases. When the viscosity of the sealing agent increases as the sealing resin 23 is heated and cured, the air bubbles 30 in the bonding layer 17 are no longer replaced with the sealing resin 23, and the air bubbles 30 are prevented from being released into the sealing resin 23. In this manner, in the second embodiment, the distance between the step 24 and the second face 1b is set to a level at which the volume of the air bubbles 30 released into the sealing resin 23 can be reduced.

Here, in the second embodiment, at the end portion covered by the sealing resin 23, the end face (first end face) of the step 24 and the end face (second end face) of the second flow path substrate 2 are formed on the same plane, but the present disclosure is not limited to such a configuration. For example, even if the third face 2a of the second flow path substrate 2 is formed at a position overlapping the scribe, and the end face of the step 24 is formed inward from the end face of the second flow path substrate 2, the size of the air bubbles 30 depends on the distance between the end face of the step 24 and the end face of the second flow path substrate 2 in the third direction D3. Therefore, the element substrate 200 may be formed by setting the distance from the end face of the step 24 to the end face of the second flow path substrate 2 so that the size of the air bubbles 30 can be reduced to a level that does not influence the wire bonding strength.

For example, if the strength standard for wire bonding is 100 mN, contact with bubbles with a volume of 5 to 10 mm³ or more may cause breakage due to the buoyancy of air bubbles in the sealing resin. If the amount of bubbles accumulated is 1/1000 or less thereof, it can be said that there is almost no damage due to contact, and thus if the volume of air bubbles in the sealing resin can be reduced to 0.005 mm³ or less, it can be said that there is almost no influence from contact load. For example, a case in which, at the end portion covered by the sealing resin 23, semicircular air bubbles with a radius equal to the distance from the end face of the step 24 to the end face of the second flow path substrate 2 are formed at the end portion of the bonding layer 17 is considered. In this case, when the thickness of the bonding layer 17 is 5 μm, the distance from the end face (first end face) of the step 24 to the end face (second end face) of the second flow path substrate 2 in the third direction D3 is desirably 200 μm or less.

In the configuration according to the second embodiment, since the size of air bubbles generated in the bonding layer 17 can be reduced and movement of air bubbles into the sealing resin 23 can be prevented, the generation of problems caused by air bubbles can be reduced. That is, the step portion provided to reduce the occurrence of problems may be provided on at least one of the first flow path substrate 1 and the second flow path substrate 2. In addition, for example, a step portion arranged in the bonding layer 17 can be formed by providing steps on both the first flow path substrate 1 and the second flow path substrate 2.

### Other Embodiments

Next, as another embodiment according to the present disclosure, a configuration in which positions at which step portions, PADs, and wires are arranged are changed will be described. Hereinafter, in the other embodiment, only components different from those in the first embodiment will be described. In the other embodiment, the same components as those in the first embodiment will be denoted with the same reference numerals, and descriptions thereof will be omitted.

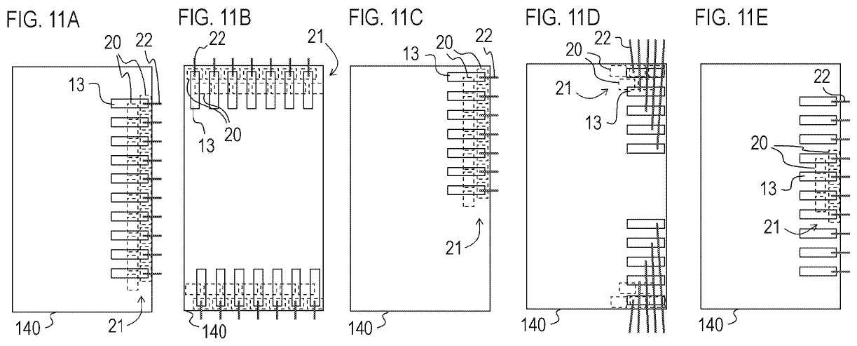

In the first embodiment, the step portion 21 is provided at both end portions of the first flow path substrate 1 in the third direction D3. In addition, the step portion 21 is formed such that the steps 20 overlap all the PADs 13 provided on the second flow path substrate 2 in the first direction D1. However, the configuration to which the present disclosure is applied is not limited thereto, and for example, the same effect can be obtained even if the steps are partially arranged in parts where connection wirings are densely arranged. Here, an example of arrangement of the PADs 13 and the steps 20 in the other embodiment will be described with reference to FIGS. 11A to 11E. FIGS. 11A to 11E are transparent plan views showing the positional relationship between the PADs 13 and the steps 20 on an element substrate 140 in the other embodiment. In FIGS. 11A to 11E, components other than the PAD 13, the step 20, the step portion 21, and the wire 22 are omitted.

FIG. 11A shows an example in which the plurality of PADs 13 are provided along one side of the long sides of the element substrate 140 which has a rectangular shape when viewed in the first direction D1 and over substantially the entire area of the element substrate 140 in the long side direction. In this example, the wires 22 connected to the PADs 13 are arranged to span across the long side from the inside to the outside of the element substrate 140, and the arrangement direction of the PADs 13 and the extension direction of the wires 22 are substantially perpendicular to each other.

In the example shown in FIG. 11A, in a configuration in which the PADs 13 are arranged side by side in a row, and the wires 22 connected to the PADs 13 extend in a direction intersecting (perpendicular to) the arrangement direction of the PADs 13, it is preferable that the steps 20 be provided to correspond to the PADs 13. This is because it is possible to effectively prevent air bubbles from moving near the wires 22 and large-sized air bubbles from being generated. Thus, in this example, two rows of steps are provided in the arrangement direction (long sides of the element substrate 140) of the PADs 13 so that the PADs 13 and at least one or more steps 20 overlap in the first direction D1. That is, the steps 20 are arranged over substantially the entire area of the element substrate 140 in the long side direction.

FIG. 11B shows an example in which the plurality of PADs 13 are provided along two short sides of the element substrate 140 and over substantially the entire area of the element substrate 140 in a short side direction perpendicular to the long side direction. In this example, the wires 22 connected to the PADs 13 are arranged to span across the short side from the inside to the outside of the element substrate 140, and the arrangement direction of the PADs 13 and the extension direction of the wires 22 are substantially perpendicular to each other.

In this example, in order to minimize the size of air bubbles and prevent air bubbles from coming into contact with the wire 22, it is preferable that the steps 20 be provided to correspond to the PADs 13. Thus, in this example, two rows of steps are provided in the arrangement direction (short sides of the element substrate 140) of the PAD 13 so that the PADs 13 and at least one or more step 20 overlap in the first direction D1. That is, the steps 20 are arranged over substantially the entire area of the element substrate 140 in the short side direction.

FIG. 11C shows an example in which the plurality of PADs 13 are provided along one side of the long sides of the element substrate 140 in a part of the element substrate 140 in the long side direction. In this example, the wires 22 connected to the PADs 13 are arranged to span across the short side from the inside to the outside of the element substrate 140, and the arrangement direction of the PADs 13 and the extension direction of the wires 22 are substantially perpendicular to each other.

In this example, in order to minimize the size of air bubbles and prevent air bubbles from coming into contact with the wire 22, it is preferable that the steps 20 be provided to correspond to the PADs 13. Thus, in this example, two rows of steps are provided in the arrangement direction (short sides of the element substrate 140) of the PAD 13 so that the PADs 13 and at least one or more step 20 overlap in the first direction D1. On the other hand, in such a configuration, it is not necessary to form the step portion 21 over the entire area of the element substrate 140 in the long side direction and it is sufficient to arrange the steps 20 in correspondence with the PADs 13.

In the example shown in FIGS. 11A to 11C, the arrangement direction of the PADs 13 intersects the extension direction of the wires 22, and the side along which the PADs 13 are arranged matches the side across which the wire 22 spans. In such a configuration, when the steps 20 are provided at positions that overlap the PADs 13 in the first direction D1, even if the wires 22 are covered with the sealing resin 23, it is possible to effectively prevent the occurrence of problems caused by air bubbles.

FIGS. 11A to 11C show a state in which steps are arranged at positions opposite to PADs, and FIGS. 11D and 11E show a state in which steps are arranged at positions of only some parts that face the PADs.

FIG. 11D shows an example in which the plurality of PADs 13 are provided in a part of the element substrate 140 in the long side direction along one side of the long sides of the element substrate 140. In this example, the wires 22 connected to the PADs 13 are arranged to span across the short side adjacent to the long side from the inside to the outside of the element substrate 140, and the arrangement direction of the PADs 13 and the extension direction of the wires 22 are substantially parallel.

In this example, in order to minimize the size of air bubbles and prevent air bubbles from coming into contact with the wire 22, it is preferable that the step portion 21 be provided along the short side across which the wire 22 spans. This is because, in order to reduce problems, it is more important to prevent air bubbles from being released to the short side across which the wire 22 spans than to prevent air bubbles from being released on the long side across which the wire 22 does not span. Therefore, in this example, the step portion 21 is formed such that the steps 20 overlap only some of the PADs 13 in the first direction D1. More specifically, the plurality of steps 20 overlap, in the first direction D1, the PADs 13 provided at positions closest to one side across which the wire 22 spans among the plurality of PADs 13. In this manner, the arrangement direction of the steps 20 can be set to intersect the arrangement direction of the PADs 13 depending on the arrangement direction of the PADs 13 and the extension direction of the wires 22.

FIG. 11E shows an example in which the plurality of PADs 13 are provided along one side of the long sides of the element substrate 140 in a part of the element substrate 140 in the long side direction. In this example, the wires 22 connected to the PADs 13 are arranged to span across the long side from the inside to the outside of the element substrate 140, and the arrangement direction of the PADs 13 and the extension direction of the wires 22 are substantially perpendicular to each other.

Depending on the configuration and size of the element substrate, areas where air bubbles are likely to be generated or areas where air bubbles are likely to become large may be biased. In such a configuration, in order to reduce the occurrence and size of air bubbles, arrangement of the step portion 21 only in some areas is also conceivable. This is because, if the number of steps 20 excessively increases, the bonding strength between the substrates may decrease. For example, in the case of a configuration in which air bubbles are likely to occur near the center of the long side of the element substrate 140, as shown in FIG. 11E, the step portion 21 may be provided only in the center of the long side. In such a case, the step portion 21 is formed such that the steps 20 overlap only some of the PADs 13 in the first direction D1.

Here, the distance between the step and the substrate that faces the step is desirably set to 0.1 μm or more in consideration of the adhesion strength between the substrates. This is because, if the adhesive layer between the step and the substrate is very thin, the adhesion strength decreases. In addition, in order to secure sufficient adhesive strength between the substrates during bonding, it is desirable that the area of the region where steps are not provided within the adhesive face be larger than the area of the region where steps are provided.

Here, in the above embodiment, all the steps forming the step portion are formed on a rectangular parallelepiped, but the present disclosure is not limited to such a configuration. For example, the steps may have a circular shape or a square shape when viewed in the protrusion direction (the first direction D1). In addition, it is not necessary for all steps forming the step portion to have the same shape or for the intervals between the steps to be constant, and the shape and the arrangement interval can be changed appropriately.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-090909, filed on Jun. 4, 2024, which is hereby incorporated by reference herein in its entirety.

What is claimed is:

1. A liquid ejection head, comprising:
an element substrate that includes:
a first flow path substrate having a first face on which an outlet for ejecting a liquid is formed and a second face opposite to the first face;
a second flow path substrate having a third face bonded to the second face of the first flow path substrate and a fourth face opposite to the third face, in which the second flow path substrate includes a flow path through which a liquid ejected from the outlet is supplied to the first flow path substrate, an energy generating element that generates energy for ejecting a liquid, and a connection terminal that is provided on the fourth face and supplies electricity to the energy generating element; and
a bonding layer that is provided between the second face and the third face and bonds the second face and the third face,
a wiring substrate having an external terminal that is electrically connected to the connection terminal;
an electrical connection portion that electrically connects the connection terminal to the external terminal; and
a sealing resin that covers the electrical connection portion and an end portion of the fourth face of the bonding layer,
wherein a step that protrudes from at least one of the second face and the third face is provided between the second face and the third face, and the step is arranged at a position overlapping the connection terminal when viewed in a first direction perpendicular to the fourth face.

2. The liquid ejection head according to claim 1,
wherein the second flow path substrate is provided with a plurality of the connection terminals, and a plurality of the steps are provided between the second face and the third face,
wherein the plurality of connection terminals and the plurality of steps are arranged side by side in a second direction along a side of the end portion of the fourth face, and
wherein, when viewed in the first direction, at least one or more of the steps overlap each of the plurality of connection terminals.

3. The liquid ejection head according to claim 2,
wherein the plurality of connection terminals and the plurality of steps are arranged at equal intervals in the second direction, and
wherein, in the second direction, a distance between the adjacent plurality of steps is smaller than a distance between the adjacent plurality of connection terminals.

4. The liquid ejection head according to claim 1,
wherein the electrical connection portion is a wire arranged to span across a side of the fourth face of the second flow path substrate.

5. The liquid ejection head according to claim 2,
wherein the plurality of steps are arranged at equal intervals in the second direction,
wherein the plurality of electrical connection portions are arranged at equal intervals in the second direction so that they are connected to the plurality of connection terminals, and
wherein, in the second direction, a distance between the adjacent plurality of steps is smaller than a distance between the adjacent plurality of electrical connection portions.

6. The liquid ejection head according to claim 1,
wherein a plurality of the steps are arranged side by side in a second direction along a side of the end portion of the fourth face,
wherein a plurality of the connection terminals are arranged side by side in a third direction along a side adjacent to the side of the fourth face, and
wherein, when viewed in the first direction, the plurality of steps overlap the connection terminal that is provided at a position closest to the side of the end portion of the fourth face among the plurality of connection terminals.

7. The liquid ejection head according to claim 1,
wherein a plurality of the connection terminals and a plurality of the steps are arranged side by side in a second direction along a side of the end portion of the fourth face, and
wherein, when viewed in the first direction, the step overlaps only some of the connection terminals among the plurality of connection terminals.

8. The liquid ejection head according to claim 1,
wherein a plurality of the connection terminals are arranged side by side in a second direction along a side of the end portion of the fourth face, and
wherein, when viewed in the first direction, the step overlaps the plurality of connection terminals.

9. The liquid ejection head according to claim 1, further comprising:
a first step row in which a plurality of the steps are arranged in a second direction along a side of the end portion of the fourth face; and
a second step row in which a plurality of the steps are arranged in the second direction and which is arranged adjacent to the first step row,
wherein the steps of the first step row and the steps of the second step row are alternately arranged in the second direction.

10. The liquid ejection head according to claim 1,
wherein a height of the step in the first direction is 5 μm or less.

11. The liquid ejection head according to claim 10,
wherein a distance between the step and a face that faces the step is at least 0.1 μm and not more than 0.3 μm.

12. The liquid ejection head according to claim 1,
wherein a first end face of the step on the end portion of the fourth face is formed on same plane as a second end face on the end portion of the fourth face of the second flow path substrate.

13. The liquid ejection head according to claim 1,
wherein a first end face of the step on the end portion of the fourth face is positioned further inside the second flow path substrate than a second end face on the end portion of the fourth face of the second flow path substrate, and
wherein a distance from the first end face to the second end face is 200 μm or less.

14. The liquid ejection head according to claim 1,
wherein, between the second face and the third face, in a face where the step is provided, an area of a region where the step is not provided is smaller than an area of a region where the step is provided.

15. The liquid ejection head according to claim 1,
wherein the energy generating element is a heating element.

16. The liquid ejection head according to claim 1,
wherein the energy generating element is a piezoelectric element.

17. The liquid ejection head according to claim 1,
wherein the energy generating element is provided on the fourth face.
